(19) United States
(12) Patent Application Publication
(10) Pub. No.: US 2006/0027997 A1
(43) Pub. Date: Feb. 9, 2006

(54) Trailer hitch conversion device

(76) Inventor: Samuel Grace, Bushnell, FL (US)

Correspondence Address: FRANK B. ARENAS, P. O. BOX 600, 2327 TAYLOR AVENUE, COLEMAN, FL, 33521, US

(21) Appl. No.: 10/912,327

(22) Filed: Aug. 5, 2004

(51) Int. Cl. B62D 53/08

(52) U.S. Cl. 280/417.1; 280/441.2

(57) ABSTRACT

An apparatus, a trailer hitch conversion device is disclosed that converts a tag-along (bumper tow) type trailer hitch to a gooseneck or fifth-wheel type trailer hitch for a pick-up truck bed comprising, a means for attachment on a tag-along (bumper tow) A-frame trailer, a means for attachment in the bed of a towing pick-up truck and a rigid means for connection between the means for attachment on a tag-along (bumper tow) A-frame trailer and the towing pick-up truck bed means for attachment.

### FIELD OF THE INVENTION

1. Field of the Invention

The present invention relates generally to trailer hitches to tow trailers behind vehicles. The invention particularly relates to tag-along (bumper tow), gooseneck and fifth-wheel hitches, as they are commonly referred to in the trailer hitch industry. The invention more particularly relates to a conversion device that converts a tag-along (bumper tow) type trailer hitch to a gooseneck or fifth-wheel hitch for improved safety, fuel efficiency and better weight distribution on the towing vehicle.

2. Description of the Prior Art

The trailer hitch industry has evolved over the years from the early 1900s. Initially, a simple pin through a hole in a plate was used to secure a trailer to a towing vehicle. The state of the art gradually improved to today's new trailer hitch designs. Most popular and typical for use today is the bumper tow hitch (sometimes called a tag-along) which uses a ball on the back bumper of the towing vehicle to interlock with a coupler (female receiver) on the A-frame of the trailer to be towed.

The tag-along trailer hitch consists of simply a ball mounted on the back bumper (or a frame that's bolted to the vehicle's undercarriage and a fixed ball-mounted platform), hooks for attaching safety chains, electric wiring harness and surge brake cable. All are categorized so they can be matched to the loads. Hitches use maximum capacity ratings based on the Gross Vehicle Weight Rating (GVWR) of the trailer. Additionally, trailers are rated for tongue weight, although GVWR is the more important of the two. Trailer hitches are broken down into four classes to allow plenty of leeway when choosing a hitch to match the maximum load of the trailer—even if it means moving up a class.

Hitches also come in different styles. Light Duty Class I, for instance, comes in a frame-mount hitch, bumper/frame mount hitch, step bumper and bumper hitch. Of the four, the frame-mount hitch is highly recommended. Frame-mounted hitches are the best for medium, and heavy duty towing. The two most common types in this category are the fixed ball-mount platform and the receiver hitch. A receiver hitch is the most versatile since it allows owners to remove the ball mount and stow it in the tow vehicle. It also allows adjustment of hitch height. For very heavy loads, the weight distributing hitch spreads out tongue weight evenly between the tow vehicles and wheels.

Like other trailering components, the hitch ball must be matched according to its rating. For Class I hitches, 2″ and 2 5/16″ are standard. Solid steel balls are recommended. It's important to match the shank of the hitch ball to the size of the ball-mount or ball-mount platform.

Located on the end of the trailer tongue, the coupler is connected to the hitch ball. Couplers come in two types: a hand wheel type and a lever type. Both styles have a coupler socket that fits snugly over the hitch ball, and a clamp that locks the ball in place.

Safety chains, which are likewise rated according to category weight, are designed to prevent the trailer from separating from the tow vehicle. In general 1 3/16″ chain is rated for 3.000 lbs., ¼″ for 5,000 lbs. and 5/16″ for 7,600 lbs.

The wiring harness and (optional) surge brake cable are the final links in the hitch assembly. The cable is linked directly to the master brake cylinder. Connecting the wiring harness and surge brake cable (if provided) is the last step in the assembly process.

Also very popular and typical for use today is the gooseneck or fifth-wheel type trailer hitch which better distributes the load from the trailer to the towing vehicle over the rear axle of the towing vehicle (usually a hitch in the bed of a pick-up truck).

“Gooseneck” has become generic for those types hitches manufactured by Gooseneck Trailer Manufacturing Company, Inc., 4400 East HWY 21, Byron, Tex., 77808-0947. All related printed documents, manuals, specifications, etc. of the above-referenced manufacturer are herein incorporated by reference. Fifth-wheel hitches are similar to the gooseneck hitches, but the kingpin (male attachment piece) is a flat disk-shaped component (such as the Southwest Wheel Company, etrailerpart.com, Dallas, Tex.). All related printed documents, manuals, specifications, etc. of the above-referenced manufacturer are herein incorporated by reference.

Fifth-wheel hitches (also referred to as 5^{th} wheel hitches) usually mount in the bed of the pick-up truck (towing vehicle), such as those made by Reese Products (Cequent Towing Products, 47774 Anchor Court West, Plymouth, Mich. 48170). All related printed documents, manuals, specifications, etc. of the above-referenced manufacturer are herein incorporated by reference.

Hitches, hitch products and accessories are offered by companies such as Sun Valley Bumper dba: Trailer Accessory SuperStore, 5599 W. Spring Mtn Rd., Las Vegas, Nev. 89146. All related printed documents, manuals, specifications, etc. of the above-referenced company are herein incorporated by reference.

There is nothing in the prior art, however, that converts a bumper tow hitch to a gooseneck or fifth-wheel hitch (and removable back to bumper tow hitch, if desired) as does this new and useful invention.

### SUMMARY OF THE INVENTION

It is an object of this invention to help prevent trailer towing accidents by allowing operators to convert A-frame type bumper tow hitch to gooseneck or fifth-wheel type trailer hitch which better distributes the load from the trailer to the towed vehicle over the rear axle of the towing vehicle (usually the bed of a pick-up truck).

It is another object of this invention to reduce fuel consumption versus a true fifth-wheel trailer by maintaining the bumper hitch towed trailer's lower wind resistance profile behind the towing vehicle while utilizing the same weight distribution advantage of a fifth-wheel type trailer.

It is a further object of this invention to provide extra storage for the users of the trailer that otherwise would not be available.

This new and useful trailer hitch conversion device accomplishes these objectives; the objects of this invention are achieved and the present invention provides a new and useful article of manufacture and method for use.

### BRIEF DESCRIPTION OF THE DRAWINGS

FIG. 1 is a front view of the trailer hitch conversion device.

FIG. 2 is a top view of the trailer hitch conversion device.

FIG. 3 depicts a perspective view of the trailer hitch conversion device.

FIG. 4 depicts the trailer hitch conversion device connected to the tag-along-trailer and towing vehicle, ready for use.

### DETAILED DESCRIPTION OF THE PREFERRED EMBODIMENT

The apparatus of the invention is conveniently fabricated by conventional and standard methods using conventional and standard materials common in the trucking, trailer, machining and metal fabrication industries. Additionally, the device incorporates an electrical “extension cord” for the trailer brake and other necessary lights required for driving on the roads.

For example, the trailer hitch conversion device (“device”) may be fabricated from aluminum, stainless steel or like metals or any other suitable metal material, even wood. The device may also be fabricated from non-metallic materials for lighter weight corrosion resistance. Theses non-metallic materials include, among others, conventional polymers such as, for example, polystyrene, polycarbonate, polyurethane, polyethylene, phenol formaldehyde resins, polybutylene, Teflon and the like. The attachment means employed for attaching the trailer hitch conversion device to the towing truck may be made of any of the above-referenced materials or any type of bolt, fastener, screw, strap, wire, cord, line, rope or webbing using Dacron, Spectra, nylon and similar materials, among others. These above-mentioned materials are examples and do not limit the types of materials that can be used to make and use the device; any and all suitable materials may be used. The components of the device may be integrated together by standard means such as welding, bolting, gluing, riveting, fastening or any other suitable means. This invention is compact and of simple construction that is easy to make and use. In best mode, the device components bolt together and apart for more compact storage and shipping.

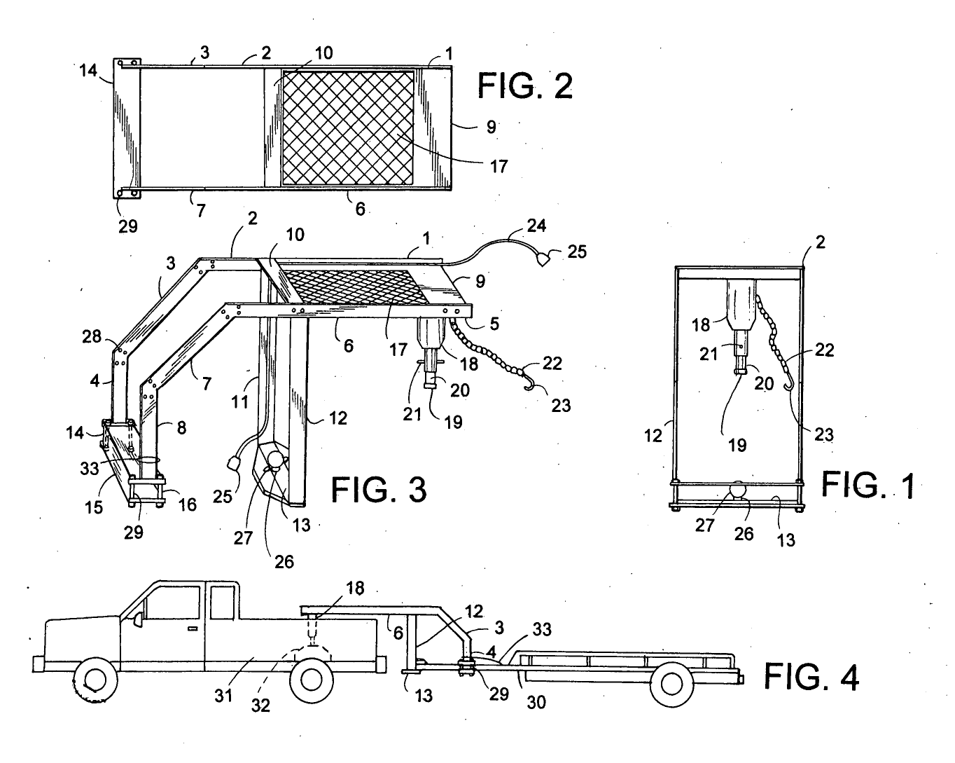

The apparatus and method of using the invention will now be further described and exemplified by reference to the various specific embodiments set forth in the drawings. FIG. 1, FIG. 2, FIG. 3, and FIG. 4 are views of the preferred embodiment of the invention.

Again referring to all 4 Figures, the assembly and fabrication of the preferred embodiment of the invention will be described in detail. The device is assembled and fabricated from standard materials and methods now used in the appropriate industries. Typically, the device is a connection means comprising a rigid frame. The preferred embodiment comprises at least one rigid vertical or nearly vertical member, at least one rigid horizontal or nearly horizontal member, and at least one rigid angled or nearly angled member. At least one secondary rigid vertical member with at least one bottom plate may also be incorporated into the horizontal or nearly horizontal member to provide stability and an attachment point for the female bumper hitch coupler of the towed trailer. The bottom plate replaces the conventional towing vehicle male hitch (ball) rear bumper attachment point with its own male hitch (ball). Alternatively, the connection means may be comprised of rigid curved members.

The attachment means employed for attaching the device to the towing truck and trailer A-frame are sufficient to accomplish support of the weight of an average or above average trailer. The preferred attachment means to the towing truck is a vertical or near vertical gooseneck or fifth-wheel kingpin adapter (best mode) to the horizontal member(s) to attach to the towing truck bed frame gooseneck or fifth-wheel hitch over the back towing truck axle for support.

The preferred (and best mode) attachment means to the trailer A-frame is at least one metal clamp. The vertical member(s) of the device and at least one secondary rigid vertical member with at least one bottom plate integrated into the horizontal or nearly horizontal member may also be used. The device may be adjustable or non-adjustable to vary the device's dimensions for different sized trailers and towing vehicles. The device is typically fabricated from steel, machined using conventional machine-shop and metal fabrication techniques such as drilling, cutting, smoothing, welding, bolting, polishing, sandblasting and painting. The device is shown with its design, functional aspects and relationship of components in scalable form in all of the drawings combined.

Now the method of making the device in the preferred embodiment and best mode will be described in detail. Referring to all of the drawings, first, suitable metal stock (typically 4″ channel) is cut to the appropriate lengths and drilled and bolted together with steel bolts 28 to form the left rail 1 from the cut metal pieces of the left top rail 2, the left angled rail 3 and the left bottom rail 4. The right rail 5 is similarly fabricated and assembled from the cut metal pieces of the right top rail 6, the right angled rail 7 and right bottom rail 8. Both assembled rails (1 & 5) are placed parallel to each other on a work table with the bottom rails (4 & 8) vertically oriented, held by temporary clamps if necessary. Then, other pieces of suitable metal stock is cut to the appropriate length to form the front top support 9 and back top support 10 and bolted perpendicular to and connecting the two parallel left 1 and right 5 rails. Two pieces of suitable metal stock are cut to the appropriate length to form the left secondary support 11 and right secondary support 12 and bolted to left top rail 2 and right top rail 6. Another piece of suitable metal stock is cut to the appropriate length to form the rear frame retainer 13 and welded perpendicular to and connecting the ends of the left and right secondary supports (11 & 12), making a rigid body of all welded and bolted pieces.

Next, the clamp(s) are cut from suitable metal flat bar stock is cut to the appropriate length to form the top support of the clamp(s) 14 and the bottom support of the clamp(s) 15. The top support(s) of the clamp(s) 14 are welded at the bottom of and perpendicular to the left bottom rail 4 and right bottom rail 8. The top 14 and bottom 15 clamp(s) are connected by the tightening bolt(s) 16 through bolt hole(s) 29 to clamp the device onto the A-frame of the trailer tongue. The optional storage rack 17 is typically expanded metal lath (#9 expanded metal) welded on and in-between the left top rail 2, right top rail 6, front top support 9 and back top support 10. The towing truck fifth-wheel vertical rigid member 18 is welded to the front top support 9 (reinforced if necessary) and the attachment means of a fifth-wheel adapter 19 is welded to the bottom of the towing truck fifth-wheel vertical rigid kingpin member 20. An adjustment pin 21 is inserted into an appropriately drilled hole(s) to fix rigidly together the vertical rigid member 18 with vertical rigid kingpin member 20 in the proper position for the towing activity. Safety chain(s) 22 with attachment hook(s) 23 are disposed onto the assembled rails (1 & 5) and the electrical extension wire 24 is attached along the assembled rails (1 & 5) (preferably on the left rail, as is the industry standard in the United States) with standard electrical plug(s) 25 on both ends. A ball-type male hitch 26 is bolted through a slot 27 (or alternately drilled holes) in the rear frame retainer 13. The invention is now complete and ready to be used. The optional surge brake cable [33], if provided by the trailer, may be attached to the towing vehicle.

Referring now to FIG. 4, to use the device in the preferred embodiment and best mode, it is attached by the operator to the trailer A-frame or chassis 30 by clamping the top clamps of the bottom vertical member(s) to bottom clamps with the bolts onto the trailer A-frame (chassis) for support. Next the attachment means of a fifth-wheel kingpin 20 is attached to the towing truck bed frame 31 into the bed fifth-wheel hitch 32 over the back towing truck axle for support. Next, the secondary rigid member with bottom plate upon which is disposed a ball-type male hitch under the tongue of the trailer. Lastly, the extension cord(s) are connected at the towing truck electrical connection and at the trailer electrical connection for electrical power for the trailer. Minor adjustments are made as necessary to the adjustment locations (if provided), safety tow chain(s) attached and the device is ready to tow the trailer. To disconnect the device, the above-referenced operation is reversed.

As will be apparent to persons skilled in the art, such as designer, machinist or fabricator in the trailer hitch industry, various modifications and adaptations of the structure and method of use above-described will become readily apparent without departure from the spirit and scope of the invention, the scope of which is defined in the claims. Although the foregoing invention has been described in detail by way of illustration and example, it will be understood that the present invention is not limited to the particular description and specific embodiments described but may comprise any combination of the above elements and variations thereof, many of which will be obvious to those skilled in the art. Additionally, the acts and actions of fabricating, assembling, using, and maintaining the preferred embodiment of this invention is well known by those skilled in the art. Instead, the invention is limited and defined solely by the following claims.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

1-11. (canceled)

12. An apparatus, a safety trailer hitch conversion device that converts a tag-along trailer hitch to a gooseneck or fifth-wheel trailer hitch for a towing pick-up truck bed receiver comprising:
a means for attachment on a tag-along A-frame trailer further comprising at least one clamp; and,
a means for attachment in a bed of a towing pick-up truck further comprising a gooseneck or fifth wheel trailer hitch and receiver; and,
a rigid means for connection between the means for attachment on the tag-along A-frame trailer and the means for attachment in the bed of the towing pick-up truck; and,
further comprising an electrical extension wire for connection from said towing pick-up truck electrical system to said tag-along A-frame trailer electrical system; and,
further comprising removable safety chains between said gooseneck or fifth wheel trailer hitch and said towing pick-up truck bed; and,
further comprising a surge brake cable attached to the safety trailer hitch conversion device and the surge brake cable linked directly to the trailer's master brake cylinder, such that if the trailer becomes separated from the towing pick-up truck the trailer's emergency brakes are triggered.

13. The device of claim 12 wherein the rigid means for connection between the means for attachment on said tag-along A-frame trailer and means for attachment in said towing pick-up truck bed further comprises at least one rigid frame.

14. The device of claim 13 further comprising at least one rigid vertical or nearly vertical member interconnected to at least one rigid horizontal or nearly horizontal member interconnected to at least one rigid angled or nearly angled member, and;
at least one secondary rigid vertical member perpendicular to and interconnected to the rigid horizontal or nearly horizontal member and;
at least one bottom plate interconnected at the bottom of the secondary rigid vertical member, all members interconnected together to comprise said rigid frame, and;
a towing vehicle male bumper hitch ball integrated into the bottom plate to provide stability and an attachment point for a female bumper hitch coupler of the towed trailer, wherein the bottom plate replaces the towing vehicle male hitch ball rear bumper attachment point with its own male hitch ball.

15. The device of claim 14 wherein all components are either welded or bolted together.

16. The device of claim 14 wherein all component dimensions are adjustable.

17. The device of claim 13 wherein a storage area is incorporated into said rigid frame.

18. A method for using the safety trailer hitch conversion device of claim 12, said method comprising the steps of:
(a) attaching a tag-along A frame trailer correctly to the device;
(b) attaching the device correctly to a towing vehicle;
(c) attaching the safety chains to the towing pick-up truck;
(d) connecting the device's electrical extension wire to the A frame trailer's electrical system and towing pick-up truck's electrical system;
(e) attaching the A frame trailer's surge brake cable to the device.
